(19) United States
(12) Patent Application Publication
(10) Pub. No.: US 2018/0170268 A1
(43) Pub. Date: Jun. 21, 2018

(54) VEHICLE GUN RACK

(71) Applicant: Richard Alan Fisher, Huntington Beach, CA (US)

(72) Inventor: Richard Alan Fisher, Huntington Beach, CA (US)

(21) Appl. No.: 15/721,504

(22) Filed: Sep. 29, 2017

Related U.S. Application Data
(63) Continuation of application No. 62/402,911, filed on Sep. 30, 2016.

(51) Int. Cl. B60R 7/14

(52) U.S. Cl. CPC B60R 7/14

(57) ABSTRACT

A vehicle gun rack having a mast supporting at least one electrically operated gun lock at the upper end thereof and a pivotal butt shoe assembly at the lower end thereof, the pivotal butt shoe assembly including a support bracket secured to the mast upon which a butt shoe is pivotally supported and movable between a horizontal position and a downwardly angled position, at least one paddle switch supported upon the mast is operatively coupled to the electrically operated gun lock, whereby an assault rifle type weapon is installed within the vehicle gun rack by inserting the bottom end of the weapon butt stock into the angled butt shoe and thereafter moving the weapon into the gun lock and pivoting the angled butt shoe to its horizontal position such that the weapon may be installed in an orientation in which the magazine thereof extends rearwardly within the host vehicle.

### CROSS-REFERENCE TO RELATED APPLICATION

This application claims the benefit of and priority under 35 U.S.C. 119(e) of U.S. Provisional Patent Application No. 62/402,911 entitled VEHICLE GUN RACK, filed Sep. 30, 2016 in the name of Richard Alan Fisher, the disclosure of which is incorporated herein by reference.

### CROSS-REFERENCE TO RELATED PATENT

This application discloses subject matter described in U.S. Pat. No. 9,708,835 entitled GUN LOCK FOR SECURING A WEAPON WITHIN A VEHICLE GUN RACK, issued Jul. 18, 2017 in the name of Richard Alan Fisher, the disclosure of which is incorporated herein by reference.

### FIELD OF THE INVENTION

This invention relates generally to gun racks and particularly to gun racks used in police vehicles and the like.

### BACKGROUND OF THE INVENTION

Law enforcement vehicles such as police cars and police cruisers typically utilize a gun rack for carrying one or more weapons within the vehicle interior. Most often, the gun rack is mounted to the vehicle floor between the two front seats in a vertically upright arrangement. In most vehicles, a pair of weapons such as a police issue assault rifle and a police issue type shotgun are secured in the gun rack in a side-by-side arrangement. A locking device is provided for each weapon to secure the weapons in the gun rack. The locking devices usually employ a “secret” release switch used by officers to quickly release the weapons when required for use. Each weapon is secured within the gun rack by standing the butt stock of the weapon in a cup-like butt stock receiver, often called a “butt shoe”, at the base of the gun rack and pivoting the weapon into the gun lock device situated on the upper portion of the gun rack.

To access a weapon for use, the police officer triggers the secret release button to open the locking device and grasps the weapon. The weapon is then pivoted and raised to withdraw the weapon's butt stock from the butt shoe. Unfortunately, the process of triggering the secret release button and thereafter lifting and pivoting the weapon to clear the butt shoe can be difficult, especially in the urgent or emergency circumstances typical of police work. In many situations, every second counts as police officers access their weapons. Time lost due to cumbersome gun racks and locking devices used therein may have life-threatening consequences. Sadly, in many instances, the presently used gun racks and gun locking devices used therein have proven to be inadequate and slow.

Faced with the need to improve the performance of gun locks, practitioners in the art have attempted to develop gun locks which more quickly and reliably release the weapon or weapons from their secured positions within the gun rack. One such improved gun lock device is set forth in U.S. Pat. No. 9,708,835 issued Jul. 18, 2017 to Richard Alan Fisher and entitled GUN LOCK FOR SECURING A WEAPON WITHIN A VEHICLE GUN RACK in which a housing supports a pair of curved lock gates in curved travel paths between an abutting closed configuration and a separated open configuration. The curved lock gates are constrained in curved travel paths by a top plate and a lower plate and each defines a curved gear rack. A coupling gear is rotatably supported within the housing and simultaneously engages both gear racks to provide movement of the lock gates between open and closed configuration. A solenoid operated locking mechanism secures the lock gates from movement away from the closed and locked configuration. A key override is provided for use in the event of an electrical failure within the host vehicle.

While this improved gun lock has substantially increased the ease of use in vehicle gun racks, there remain other limitations and challenges which continue to require the attention of practitioners skilled in the art. One significant problem that has arisen relates to the use of larger capacity magazines in the police issue assault rifle. Because these larger capacity magazines, often holding 30 rounds, extend an increased distance from the weapon's receiver, they interfere with operation of the present day gun racks as the extended magazine tends to interfere with placing the weapon into the gun rack with the magazine pointing rearwardly. While it is highly preferable to install the assault rifle type weapons with the magazine pointing rearwardly to avoid access by unauthorized individuals to the magazine, present-day gun racks force the user to install the assault rifle within the gun rack with the magazine extending forwardly rather than the preferred rearward extension.

Because locking an assault rifle within a gun rack having the magazine extend forwardly allows an unauthorized person to remove the magazine and thereby steal the magazine, such forwardly extending orientation of the assault rifle magazine is highly undesirable. In addition to the undesirable result of unauthorized persons stealing a magazine and having the lethal rounds stored therein, the absence of the magazine from the assault rifle type weapon renders it virtually useless to the police officer. In the worst of circumstances, a police officer may under emergency circumstances reach for the assault rifle only to then learn that the magazine is missing and the weapon is virtually ineffective.

There arises therefore a need in the art for ever more improved gun racks. There arises a further continuing and unresolved need in the art for gun racks that provide faster and more reliable separation of a weapon from a gun rack and facilitate the locking of an assault rifle type weapon into the gun rack with the magazine extending rearwardly while maintaining the required security for weapons within the vehicle.

### SUMMARY OF THE INVENTION

Accordingly, it is a general object of the present invention to provide an improved gun rack. It is a more particular object of the present invention to provide an improved gun rack which speeds the withdrawal of a weapon from the gun rack. It is a further object of the present invention to provide an improved gun rack having a more easily actuated lock release system. It is a still more particular object of the present invention to provide an improved gun rack that accommodates the locking of an assault rifle type weapon within the gun rack such that the magazine extends rearwardly.

In accordance with the present invention, there is provided a vehicle gun rack having a mast supporting at least one electrically operated gun lock at the upper end thereof and a pivotal butt shoe assembly at the lower end thereof, the pivotal butt shoe assembly including a support bracket secured to the mast upon which a butt shoe is pivotally supported and movable between a horizontal position and a downwardly angled position, at least one paddle switch supported upon the mast operatively coupled to the electrically operated gun lock, whereby an assault rifle type weapon is installed within the vehicle gun rack by inserting the bottom end of the weapon butt stock into the angled butt shoe and thereafter moving the weapon into the gun lock and pivoting the angled butt shoe to its horizontal position such that the weapon may be installed in an orientation in which the magazine thereof extends rearwardly within the host vehicle.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of the present invention vehicle gun rack in an illustrative vehicle environment;

FIG. 2 sets forth a perspective view of a vehicle gun rack constructed in accordance with the present invention;

FIGS. 3A and 3B set forth partial side elevation views of the pivotal butt shoe structure of the present invention vehicle gun rack;

FIG. 4 sets forth an enlarged perspective view of the butt shoe and it's support within the present invention vehicle gun rack;

FIGS. 5A, 5B and 5C set forth sequential views of the installation of an illustrative assault rifle type weapon into the present invention vehicle gun rack; and

FIG. 6 sets forth an exploded assembly view of the paddle switch mechanism of the present invention vehicle gun rack.

### DESCRIPTION OF THE PREFERRED EMBODIMENTS OF THE INVENTION

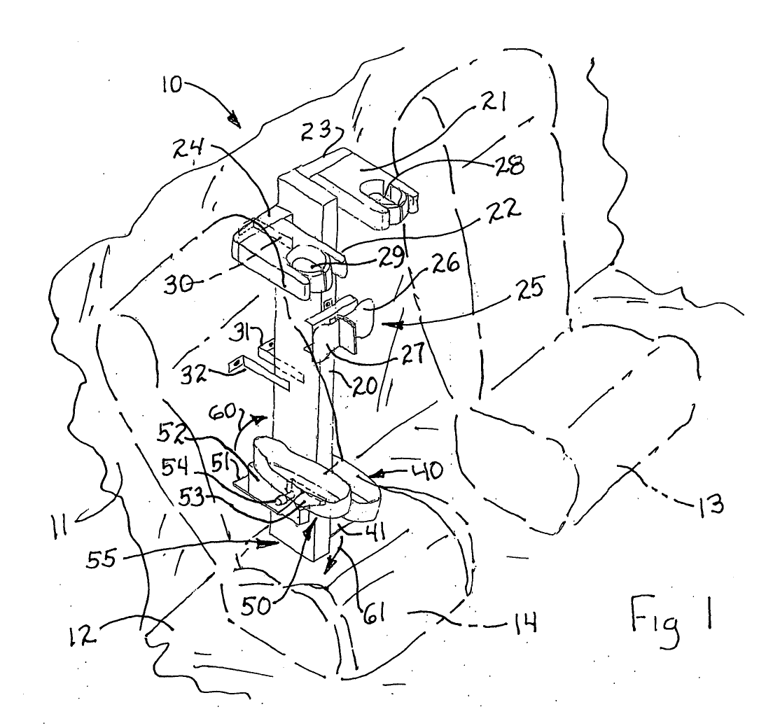

FIG. 1 sets forth a perspective view of the present invention gun rack generally referenced by numeral 10 within an illustrative vehicle environment. In accordance with the front seat interior environment of a police vehicle, a driver seat 13 and a passenger seat 14 are secured in a spaced apart arrangement upon a vehicle floor 12. In further accordance with conventional police vehicle fabrication, a passenger barrier typically referred to as a “prisoner screen” 11 extends vertically from vehicle floor 12. In accordance with the preferred use of the present invention, gun rack 10 is situated between front seats 13 and 14 and is supported by a plurality of brackets 30, 31, 32 and 33 against prisoner screen 11 (bracket 33 not shown). In a typical installation, vehicle gun rack 10 is secured to prisoner screen 11 using secure threaded fasteners or the like. In most installations, tamperproof fasteners are the preferred fabrication. However, the essential function of such fasteners is to provide a secure rigid attachment of vehicle gun rack 10 to prisoner screen 11. It will be recognized that while FIG. 1 illustrates the typical installation of the present invention vehicle gun rack in a vehicle environment, the present invention gun rack is also suitable for use in other environments such as wall mounting or the like.

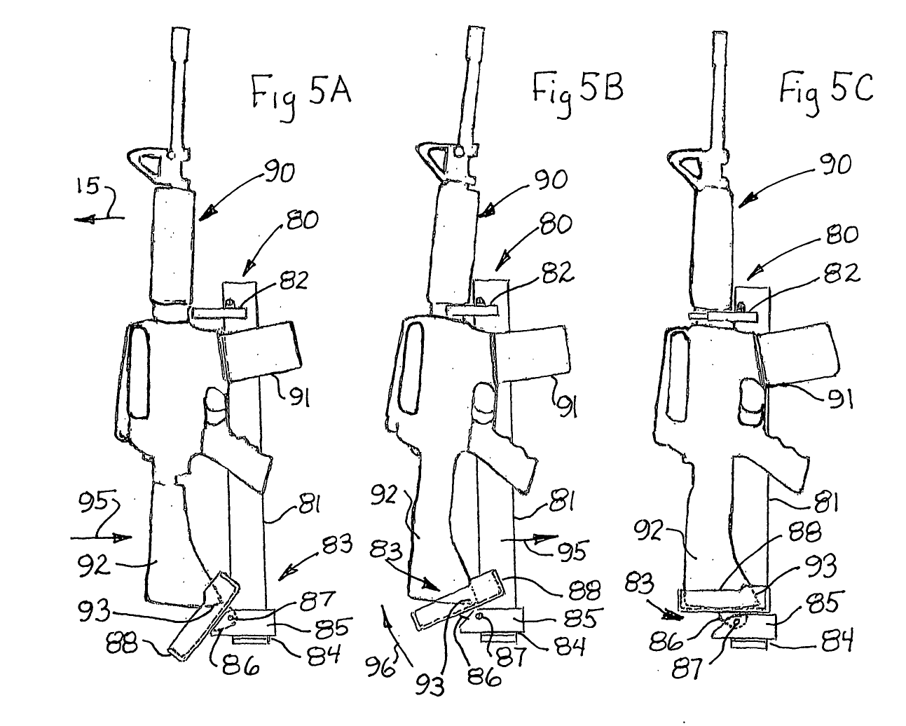

The structure of vehicle gun rack 10 is set forth below in greater detail. However, suffice it to note here that vehicle gun rack 10 includes a center mast 20, preferably formed in a generally rectangular cross-section shapes and preferably formed of a rigid material such as steel or other metal, secured to prisoner screen 11 by a plurality of rearwardly extending brackets 30, 31, 32 and 33 (bracket 33 not seen). A pair of lock brackets 23 and 24 extend outwardly from opposite sides of mast 20. Bracket 23 supports a gun lock 21 while bracket 24 supports a gun lock 22. In the preferred fabrication of the present invention, gun locks 21 and 22 comprise gun locks constructed in accordance with the above referenced U.S. Pat. No. 9,708,835 which provide electrically actuated gun receptacles 28 and 29. The gun receptacles are able to receive and securely lock a portion of a weapon in the manner set forth below in FIGS. 5A through 5C.

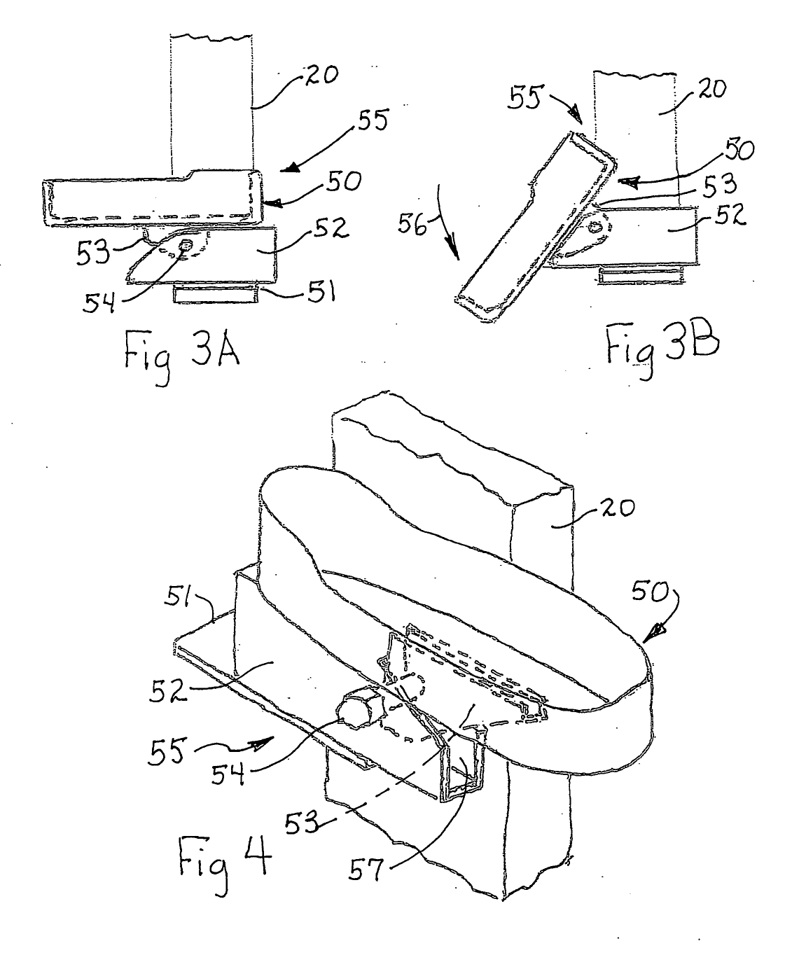

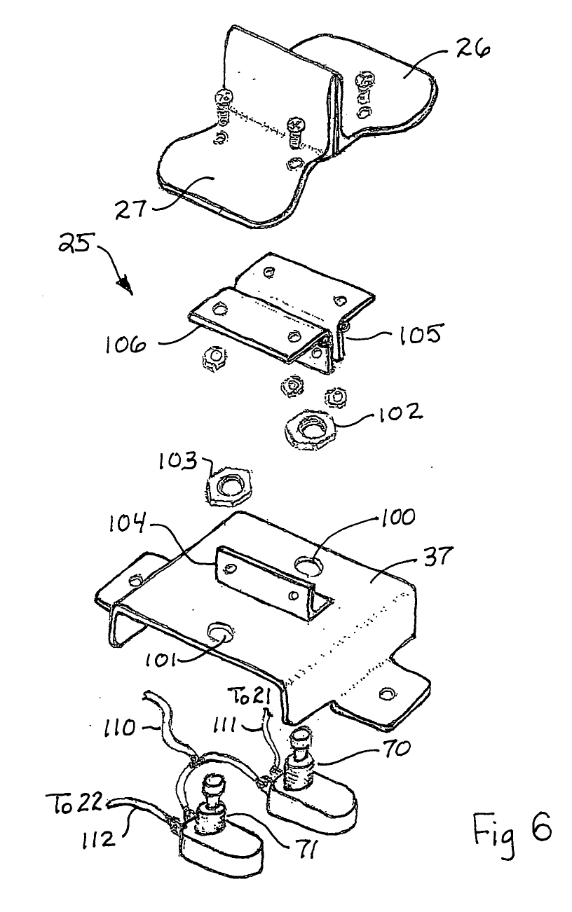

Vehicle gun rack 10 further includes a paddle switch assembly 25 supporting a pair of pivotally movable paddles 26 and 27. The structure of paddle switch assembly 25 is set forth below in FIG. 6 in greater detail. Suffice it to note here that paddle switch assembly 25 includes a pair of momentary switches operated by movement of paddles 26 and 27 to apply appropriate electrical signals to gun locks 21 and 22 in order to control the opening of the gun locks. Vehicle gun rack 10 further includes a bracket 41 joined to the lower end of mast 20 and extending outwardly therefrom to support a butt shoe 40. Vehicle gun rack 10 further includes a bracket 51 extending outwardly from mast 20 which supports a pivot base 52. Pivot base 52 receives a pivot block 53 in a pivotal attachment provided by a pivot pin 54. Pivot block 53 further supports a butt shoe 50. The combination of butt shoe 50, pivot block 53, pivot pin 54, pivot base 52 and bracket 51 provides a pivotal butt shoe assembly 55 set forth below in greater detail in FIGS. 3 and 4 that allows butt shoe 52 pivot between the horizontal position shown in FIG. 1 and the downwardly angled position shown in FIG. 5A in the direction indicated by arrows 60 and 61. The function of pivotal butt shoe assembly 55 provides the capability of vehicle gun rack 10 by which an assault rifle type weapon having a large capacity magazine may be secured within vehicle gun rack 10 in a position in which the magazine extends rearwardly toward prisoner screen 11.

In operation, the user is able to install a shotgun type weapon within vehicle gun rack 10 by pressing paddle 26 of paddle switch assembly 25 causing gun lock 21 to open and expose gun receptacle 28 therein. The user then inserts a shotgun (not shown) butt stock into butt shoe 40 and pivots the shotgun such that the upper portion of the shotgun is received within gun receptacle 28. Thereafter, the user moves gun lock 21 to the locked position thereby completing the securing of the shotgun type weapon. In accordance with an important advantage of the present invention, the user is able to install an assault rifle type weapon within pivotal butt shoe assembly 55 and gun lock 22 by pressing paddle 27 of paddle switch assembly 25 to open gun lock 22 and expose gun receptacle 29 thereof. Thereafter, and in accordance with an important aspect of the present invention shown in FIGS. 5A through 5C below, the user is then able to orient the assault rifle such that the magazine extends rearwardly toward prisoner screen 11 and install the assault rifle in accordance with the operational steps set forth below in FIGS. 5A through 5C below. It is of importance to note here that, in accordance with an important aspect of the present invention, the user installs the assault rifle within vehicle gun rack 10 by initially placing the butt stock within butt shoe 50 and pivoting the assault rifle and pivotal butt shoe assembly 55 to position the upper portion of the assault rifle within gun receptacle 29 in the operation shown below. In the absence of the pivotal movement of butt shoe 50 provided by pivotal butt shoe assembly 55 this pivoting installation of an assault rifle in the magazine rearward orientation is prevented as the magazine interferes with movement into the vehicle gun rack.

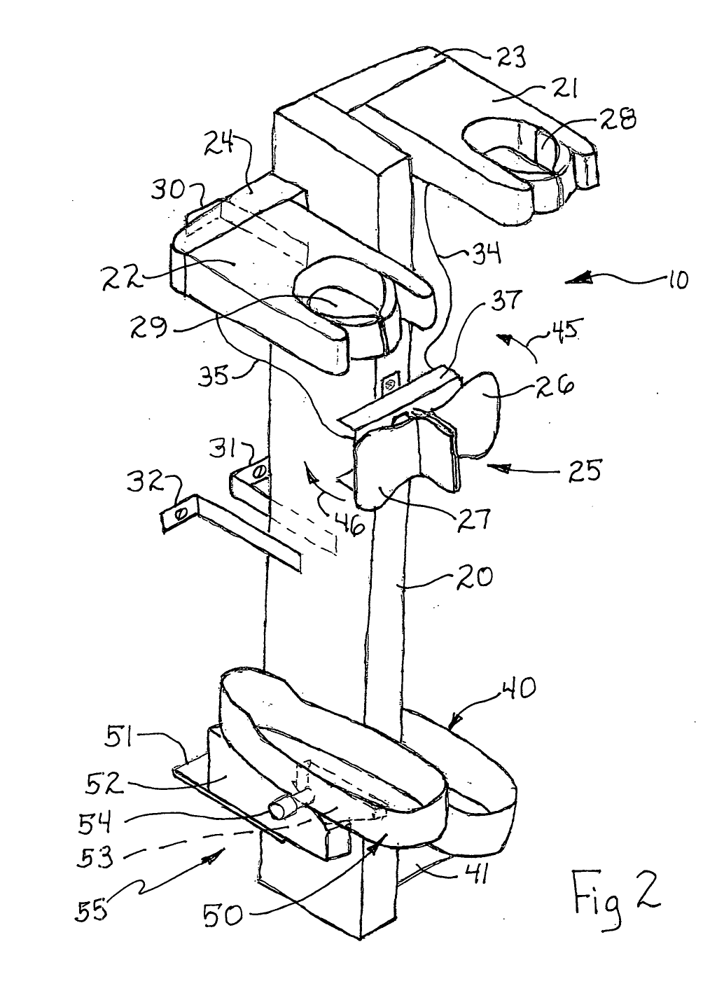

FIG. 2 sets forth a perspective view of vehicle gun rack 10. As described above, vehicle gun rack 10 includes a center mast 20 supported by a plurality of rearwardly extending brackets 30, 31, 32 and 33 (bracket 33 not shown). Brackets 30 through 33 are joined to mast 20 by conventional welding or other secure attachment. Vehicle gun rack 10 further includes a pair of brackets 23 and 24 extending outwardly on opposite sides of the upper portion of center mast 20. Bracket 23 supports a gun lock 21 while bracket 24 supports a gun lock 22. Gun locks 21 and 22 are preferably fabricated in accordance with the above referenced U.S. Pat. No. 9,708,835 which provide electrically operated locking gates to alternatively open and close about respective gun receptacles 28 and 29.

Vehicle gun rack 10 further includes a paddle switch assembly 25 which is set forth below in greater detail in FIG. 6. Paddle switch assembly 25 includes a bracket 37 secured to the front face of mast 20. As is better seen in FIG. 6, paddle switch assembly 25 includes a pair of momentary contact switches 70 and 71 which are positioned beneath paddles 26 and 27. Paddles 26 and 27 are pivotally supported and thus are pivotally movable when pressed in the directions indicated by arrows 45 and 46. This pivotal movement of paddles 26 and 27 actuates momentary contacts switches 70 and 71 (seen in FIG. 6). Gun locks 21 and 22 are electrically operated and are coupled to momentary switches 70 and 71 within paddle switch assembly 25 by conventional connecting wires 34 and 35 respectively.

In operation, the user having installed an assault rifle and a shotgun within vehicle gun rack 10 is able to release gun lock 21 by pressing against paddle 26 of paddle switch assembly 25 and pushing it in the direction indicated by arrow 45. By means set forth below in FIG. 6 in greater detail, this movement of paddle 26 provides completion of the electrical circuit that opens gun lock 21. Similarly, the user is able to release an assault rifle secured within butt shoe 50 and gun lock 22 by pressing paddle 27 of paddle switch assembly 25 in the direction indicated by arrow 46. The movement of paddle 27 produces a momentary completion of the electrical control circuit operative upon gun lock 22 releasing the assault rifle and allowing the withdrawal of the assault rifle from vehicle gun rack 10 in the manner described below in FIGS. 5A through 5C. The ability of the user to open the selected gun lock and thereby release the selected weapon by simply touching either paddle 26 or 27 provides a high-speed and reliable release of the desired weapon.

By way of example, considering a police officer seated in the driver's seat of the vehicle arriving at a potentially urgent scene. The police officer stops the car and reaches across his or her body with the left hand toward the selected weapon. In this single-handed fluid movement, the officer extends either fingers or a thumb to move the paddle (paddle 26 or 27), thereby opening the gun lock (gun lock 21 or 22), and grasping the selected weapon. As a result of the operation of the present invention, the officer has obtained control of the weapon in his or her left hand and completed the withdrawal of the weapon in a single continuous movement. In accordance with an important advantage of the present invention gun rack, it will be noted that the officer is not required to direct his or her attention to the gun rack in order to withdraw a selected weapon. Rather, the officer is able to direct his or her attention to the surroundings and activities as the weapon is being withdrawn. This is of great advantage to a police officer arriving at a potentially difficult seen and having a need to quickly and immediately survey the scene and access a weapon. It will be noted that the same fluid action is available to an officer seated in the passenger seat with the exception that the officer would likely reach for the weapon using the officer's right hand.

Vehicle gun rack 10 further includes a bracket 41 supporting a butt shoe 40 in a fixed attachment. Vehicle gun rack 10 further includes a bracket 51 joined to the opposite side of mast 20 which supports a pivot base 52. Pivot base 52 further supports a pivot block 53 in a pivotal attachment secured by a pivot pin 50. A butt shoe 50 is supported upon pivot block 53. As mentioned above, the combination of pivot base 52, pivot block 53, pivot pin 54 and butt shoe 50 forms pivotal butt shoe assembly 55. Pivotal butt shoe assembly 55 is operable in accordance with the sequence set forth below in FIGS. 5A through 5C to facilitate the installation of an assault rifle having an extended magazine in an orientation characterized by a rear word extension of the magazine.

FIGS. 3A and 3B set forth partial side elevation views of the operation of pivotal butt shoe assembly 55. FIG. 3A sets forth the configuration of pivotal butt shoe assembly 55 characterized by butt shoe 50 having been pivoted to a horizontal position. FIG. 3B sets forth the configuration of pivotal butt shoe assembly 55 in its normal downwardly angled orientation.

More specifically, with particular attention to FIG. 3A, and as is described above, vehicle gun rack 10 includes mast 20 upon which bracket 51 supports pivot base 52. As is also described above, pivot base 52 supports pivot block 53 in a pivotal attachment provided by pivot pin 54. Butt shoe 50 is supported by pivot block 53. In accordance with the preferred fabrication of the present invention, it will be noted that pivot pin 54 is positioned “off-center” with respect to butt shoe 50 and pivot block 53. This off-center positioning of pivot pin 54 results in a greater distribution of weight with respect to pivot pin 54 in the forward portion of butt shoe 50 causing butt shoe 50 to naturally pivot under the urging of gravity to the downwardly angled configuration shown in FIG. 3B.

With particular attention to FIG. 3B, and as is described above, vehicle gun rack 10 includes mast 20 upon which bracket 51 supports pivot base 52. As is also described above, pivot base 52 supports pivot block 53 in a pivotal attachment provided by pivot pin 54. Butt shoe 50 is supported by pivot block 53. With pivot pin 54 positioned in the above mentioned off-center relationship to butt shoe 50, the greater distribution of weight with respect to pivot pin 54 in the forward portion of butt shoe 50 causes butt shoe 50 to naturally pivot under the urging of gravity in the direction indicated by arrow 56 to the downwardly angled configuration shown. The tendency of butt shoe 50, when empty, to assume the downwardly angled configuration shown in FIG. 3B facilitates the ease of weapon installation set forth in FIGS. 5A through 5C below. As will be described more fully in connection therewith, the angled configuration of butt shoe 50 positions butt shoe 50 at the desired orientation to receive the forward portion of the butt stock of an assault rifle during installation.

FIG. 4 sets forth an enlarged perspective view of pivotal butt shoe assembly 55. As mentioned above, bracket 51 is secured to mast 20 by conventional attachment such as welding or the like (not shown). Bracket 51 supports pivot base 52 which defines a channel 57 therein. Pivot block 53 is received within channel 57 of pivot base 52 and is pivotally supported by pivot pin 50. Butt shoe 50 is supported upon the upper edge of pivot block 53 and is secured thereto by conventional attachment such as welding or the like (not shown). Pivot block 53 is freely movable within channel 57 such that the above described offset of pin 54 facilitates the gravity induced downwardly angled position that butt shoe 50 naturally assumes.

FIGS. 5A, 5B and 5C sets forth the sequential operation by which an assault rifle type weapon 90 is installed within a vehicle gun rack constructed in accordance with the present invention and generally referenced by numeral 80. Vehicle gun rack 80 is substantially identical to vehicle gun rack 10 set forth and described above with the difference being found in the omission of a second weapon installation. For purposes of illustration, vehicle gun rack 80 shows an embodiment of the present invention utilized in receiving and securing a single assault rifle 90. It will be apparent to those skilled in the art that vehicle gun rack 80 is substantially identical to vehicle gun rack 10 set forth and described above in its structure pertaining to pivotal butt shoe assembly 55 and gun lock 22 (both seen in FIG. 1). Thus, the descriptions and illustrations of vehicle gun rack 80 set forth in FIGS. 5A through 5C will be understood to be equally applicable to and equally descriptive of the descriptions and illustrations of vehicle gun rack 10 set forth above with the exception of the single weapon use of vehicle gun rack 80.

More specifically with reference to FIG. 5A, a vehicle gun rack 80 includes a mast 81 supporting an electrically operated gun lock 82 and a pivotal butt shoe assembly 85. Pivotal butt shoe assembly 85 is substantially identical to butt shoe assembly 55 (seen in FIG. 4) and includes a bracket 84 extending from mast 81 and supporting a pivot base 85. A pivot block 86 is pivotally joined to pivot base 85 by a pivot pin 87. A butt shoe 88 is supported upon pivot block 86 and secured thereto by conventional attachment (not shown). An assault rifle 90 is constructed in accordance with conventional fabrication and includes a large capacity magazine 91 and a butt stock 92. Butt stock 92 further defines a corner portion 93.

In operation, with vehicle gun rack 80 oriented such that gun lock 82 thereof is open in the forward direction of the host vehicle indicated by arrow 15, assault rifle 90 is positioned and oriented such that magazine 91 extends rearwardly within the host vehicle in the direction opposite to arrow 15 and such that corner portion 93 of butt stock 92 extends into butt shoe 88. It will be noted that in accordance with the above described offset positioning of pin 87, butt shoe 88 automatically assumes the downwardly angled position shown in FIG. 5A. This downward angle of butt shoe 88 is important to the ease of insertion of corner portion 93 of butt stock 92 at the initial step of assault rifle installation. At this point, the user then moves assault rifle 90 into vehicle gun rack 80 in the direction indicated by arrow 95 such that magazine 91 passes beneath gun lock 82 and corner portion 93 of butt stock 92 presses against the interior of butt shoe 88 at a point above pivot pin 87. The force of corner portion 93 against the interior bottom surface of butt shoe 88 produces a rotational force upon butt shoe 88 in the direction indicated by arrow 96 in FIG. 5B.

FIG. 5B sets forth an intermediate step in the installation of assault rifle 90 into vehicle gun rack 80. As described above, vehicle gun rack 80 includes mast 81 supporting electrically operated gun lock 82 and pivotal butt shoe assembly 85. Pivotal butt shoe assembly 85 is substantially identical to butt shoe assembly 55 (seen in FIG. 4) and includes bracket 84 extending from mast 81 and supporting pivot base 85. Pivot block 86 is pivotally joined to pivot base 85 by pivot pin 87. Butt shoe 88 is supported upon pivot block 86 and secured thereto by conventional attachment (not shown). Assault rifle 90 is constructed in accordance with conventional fabrication and includes large capacity magazine 91 and butt stock 92 further defining corner portion 93.

In the intermediate position shown in FIG. 5B, the continued movement of assault rifle 90 in the direction indicated by arrow 95 results in pivoting butt shoe 88 upwardly in the direction indicated by arrow 96 and moving magazine 91 beneath gun locked 82. At this point, the user completes the installation of assault rifle 90 within vehicle gun rack 80 by continued force in the direction indicated by arrow 95 until butt shoe 88 has pivoted fully to a horizontal position and until the bottom portion of butt stock 92 is received within butt shoe 88 assuming the configuration shown in FIG. 5C.

FIG. 5C sets forth the completed installation of assault rifle 90 into vehicle gun rack 80. As described above, vehicle gun rack 80 includes mast 81 supporting electrically operated gun lock 82 and pivotal butt shoe assembly 85. Pivotal butt shoe assembly 85 is substantially identical to butt shoe assembly 55 (seen in FIG. 4) and includes bracket 84 extending from mast 81 and supporting pivot base 85. Pivot block 86 is pivotally joined to pivot base 85 by pivot pin 87. Butt shoe 88 is supported upon pivot block 86 and secured thereto by conventional attachment (not shown). Assault rifle 90 is constructed in accordance with conventional fabrication and includes large capacity magazine 91 and butt stock 92 further defining corner portion 93.

In the position shown in FIG. 5C, assault rifle 90 is fully installed within vehicle gun rack 80. This installation is completed as gun lock 82 has been locked and secures the upper portion of assault rifle 90 and as the lower portion of butt stock 92 is fully received within butt shoe 88. Also but shoe 88 has been pivoted to its fully horizontal position. At this point, assault rifle 90 is secured or within vehicle gun rack 80 and magazine 91 extends rearwardly of vehicle gun rack 80 providing an important advantage for the present invention vehicle gun rack.

The operation by which assault rifle 90 is removed from vehicle gun rack 80 is substantially the reverse of the above described process by which an assault rifle was installed within the vehicle gun rack. As mentioned above, the user actuates a paddle switch which opens gun lock 82 and grasps the assault rifle. There after the user moves assault rifle 90 to the intermediate position shown in FIG. 5B by pivoting assault rifle 90 and thereafter withdrawing butt stock 92 from butt shoe 88 in the manner shown in FIG. 5A. It will be noted that in removing assault rifle 90 from gun rack 80 the pivotal motion of butt shoe 88 is the key to allowing assault rifle 90 to be pivoted and withdrawn from vehicle gun rack 80. In essence, the pivoting movement of butt shoe 88 allows butt shoe 88 to “drop down” thereby providing clearance for the bottom portion of butt stock 92 to be withdrawn from butt shoe 88.

FIG. 6 sets forth a perspective assembly view of paddle switch assembly 25. Paddle switch assembly 25 includes a bracket 37 defining a pair of apertures 100 and 101. A flange 104 is secured to bracket 37 by conventional attachment such as welding or the like. A pair of momentary contact switches 70 and 71 extend through apertures 100 and 101 respectively and are secured to bracket 37 using fasteners 102 and 103 respectively. A pair of hinges 105 and 106 are joined to opposite sides of flange 104 by conventional fasteners (not shown). Hinge 105 is secured to a paddle 26 while hinge 106 is secured to a paddle 27. The combination of flange 104, hinge 105 and hinge 106 supports paddles 26 and 27 above the actuators of momentary switches 70 and 71. Accordingly, the pivotal movement of paddle 26 about hinge 105 moves paddle 26 downwardly upon the actuator of momentary switch 70. Similarly, the downward movement of paddle 27 moves paddle 27 downwardly upon the actuator of momentary switch 71. Momentary switches 70 and 71 each have one terminal coupled to a common ground connection wire 110. Momentary switch 70 is connected to gun lock 21 by a wire connection 111 while momentary switch 71 is connected to gun lock 22 by a connecting wire 112. Thus, momentary switches 70 and 71 independently operate gun lock 21 and gun lock 22 respectively.

What has been shown is a vehicle gun rack having a mast supporting at least one electrically operated gun lock at the upper end thereof and a pivotal butt shoe assembly at the lower end thereof, the pivotal butt shoe assembly including a support bracket secured to the mast upon which a butt shoe is pivotally supported and movable between a horizontal position and a downwardly angled position, at least one paddle switch supported upon the mast operatively coupled to the electrically operated gun lock, whereby an assault rifle type weapon is installed within the vehicle gun rack by inserting the bottom end of the weapon butt stock into the angled butt shoe and thereafter moving the weapon into the gun lock and pivoting the angled butt shoe to its horizontal position such that the weapon may be installed in an orientation in which the magazine thereof extends rearwardly within the host vehicle.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A vehicle gun rack comprising:
a mast having an upper end and a lower end;
an electrically operated gun lock secured to said upper end;
a pivotal butt shoe assembly secured to said lower end having a pivotal butt shoe assembly including a support bracket secured to said mast, a pivotally supported butt shoe movable between a horizontal position and a downwardly angled position, a paddle switch supported upon said mast operatively coupled to said electrically operated gun lock, whereby an assault rifle type weapon is installed within the vehicle gun rack by inserting the bottom end of the weapon butt stock into said angled butt shoe and thereafter moving the weapon into said gun lock and pivoting said angled butt shoe to its horizontal position such that the weapon may be installed in an orientation in which the magazine thereof extends rearwardly within a host vehicle.

2. A gun rack comprising:
a mast having an upper end and a lower end;
a first gun lock supported proximate said upper end of said mast having a first gun receptacle for receiving a portion of a weapon and a first electrically operated lock for closing and locking said first gun receptacle;
a pivotable butt shoe constructed to receive a lower end of a weapon butt stock;
a pivotable butt shoe support supporting said pivotable butt shoe proximate said lower end of said mast in a pivotable attachment; and
a switch operable to release said electrically operated lock,
whereby a weapon may be secured within said gun rack by inserting a portion of the weapon butt stock into said pivotable butt shoe and pivoting said pivotable butt shoe within said pivotable butt shoes support to a generally horizontal position while inserting a portion of the weapon into said gun lock receptacle.

3. The gun rack set forth in claim 2 wherein said pivotable butt shoe support includes an off center pivot pin and wherein said pivotable butt shoe is pivotally movable about said pivot pin between a generally horizontal position and a downwardly angled position.

4. The gun rack set forth in claim 3 wherein said switch includes a first momentary contact switch supported upon said mast and a first movable paddle positioned for pivotal movement between a first position in which said first momentary contact switch is not activated and a second position in which said first momentary contact switch is activated.

5. The gun rack set forth in claim 4 further including a fixed butt shoe secured to said mast proximate said lower end and a second gun lock secured to said mast proximate said upper end.

6. The gun rack set forth in claim 5 further including a second gun lock supported proximate said upper end of said mast having a second gun receptacle for receiving a portion of a weapon and a second electrically operated lock for closing and locking said second gun receptacle;
